(19) United States
(12) Patent Application Publication
(10) Pub. No.: US 2023/0265289 A1
(43) Pub. Date: Aug. 24, 2023

(54) SILICONE MATERIAL WITH SCRATCH RESISTANCE, HIGH ELONGATION AND HIGH RELISIENCE

(71) Applicant: Xiamen Hexin Technology Co., Ltd., Xiamen (CN)

(72) Inventors: Zhennan Xu, Xiamen (CN); Zhongxin Duan, Xiamen (CN)

(21) Appl. No.: 17/700,403

(22) Filed: Mar. 21, 2022

(30) Foreign Application Priority Data
Feb. 21, 2022 (CN) 202210156289.0

(51) Int. Cl. C08L 83/04

(52) U.S. Cl. CPC C08L 83/04; C08L 2205/03; C08L 2205/025

(57) ABSTRACT

The invention relates to a silicone material with scratch resistance, high elongation and high resilience, comprising the following parts by weight of raw materials: 0˜100 parts of 107 crude silicone, 0˜100 parts of 110 crude silicone, 2˜20 parts of structure inhibitor, 0.1˜3 parts of methyl silicone oil, 1˜40 parts of fumed silica, 1˜40 parts of precipitated silica, 2˜15 parts of anti-frost agent, 2˜20 parts of anti-yellowing agent and 0.2˜3 parts of platinum catalyst. The advantages of the invention: it provides a silicone material with bright color, delicate touch, excellent anti-scratch performance, high elongation and resilience; it is convenient to produce, hence suitable for industrial mass production; it is available in black, light and transparent; it is latex-free, contains no ammonia, does not irritate or cause allergies to the skin; in all, it applies to make various elastic products with high requirements on color, surface, elongation, elasticity, touch and scratch resistance.

### BACKGROUND OF THE INVENTION

### Field of the Invention

The invention relates to a silicone material with scratch resistance, high elongation and high resilience.

### Description of Related Art

Silicone is a very common chemical product. However, sometimes due to the denaturation of the silicone, the service life is affected. The existing silicone materials have many deficiencies in scratch resistance, elongation, resilience, etc., hence how to provide a scratch-resistant, high elongation and high resilience silicone material has become the research direction.

### SUMMARY OF THE INVENTION

The purpose of the invention is to provide a silicone material with scratch resistance, high elongation and high resilience, in order to solve the proposed problems in the above technical background.

To solve the above technical problems, the technical solution provided by the invention is: a silicone material with scratch resistance, high elongation and high resilience, comprising the following parts by weight of raw materials: 0˜100 parts of 107 crude silicone, 0˜100 parts of 110 crude silicone, 2˜20 parts of structure inhibitor, 0.1˜3 parts of methyl silicone oil, 1˜40 parts of fumed silica, 1˜40 parts of precipitated silica, 2˜15 parts of anti-frost agent, 2˜20 parts of anti-yellowing agent and 0.2˜3 parts of platinum catalyst.

Preferably, the silicone material with scratch resistance, high elongation and high resilience according to claim 1 is produced through the following steps:

1) add 107 crude silicone, 110 crude silicone, structure inhibitor, methyl silicone oil, fumed silica, precipitated silica, anti-frost agent, anti-yellowing agent and platinum catalyst to the kneader in order;

2) after maintaining the speed of 5˜50r/min, the temperature of 100° C.˜200° C., and 30˜120 min, the material kneading is completed;

3) filter to obtain the semi-finished silicone material;

4) after the surface of the semi-finished silicone material is cured, spray touch oil on the surface of the semi-finished silicone material.

Preferably, the raw material ratio of the touch oil is: 20˜80 parts of vinyl-terminated polymethyl siloxane, 1˜20 parts of silica, 2˜20 parts of structure inhibitor, 0.1˜3 parts of methyl silicone oil, 2˜15 parts of anti-frost agent, 2˜20 parts of anti-yellowing agent, 0.2˜3 parts of platinum catalyst, 10˜100 parts of organic solvent.

The advantages of the invention: it provides a silicone material with bright color, delicate touch, excellent anti-scratch performance on the surface, high elongation and resilience; it is convenient to produce, hence suitable for industrial mass production; it is available in black, light and transparent; it is latex-free, contains no ammonia, does not irritate or cause allergies to the skin; in all, it applies to make various elastic products with high requirements on color, surface, elongation, elasticity, touch and scratch resistance.

### DETAILED DESCRIPTION OF THE PREFERRED EMBODIMENTS

The invention is further described with specific embodiments, which are however not to limit the invention.

### Embodiment 1

A silicone material with scratch resistance, high elongation and high resilience, comprising the following parts by weight of raw materials: 0 parts of 107 crude silicone, 100 parts of 110 crude silicone, 2 parts of structure inhibitor, 3 parts of methyl silicone oil, 1 parts of fumed silica, 40 parts of precipitated silica, 2 parts of anti-frost agent, 20 parts of anti-yellowing agent and 0.2 parts of platinum catalyst.

A silicone material with scratch resistance, high elongation and high resilience according to claim 1 is produced through the following steps:
1) add 107 crude silicone, 110 crude silicone, structure inhibitor, methyl silicone oil, fumed silica, precipitated silica, anti-frost agent, anti-yellowing agent and platinum catalyst to the kneader in order;
2) after maintaining the speed of 5˜50r/min, the temperature of 100° C.˜200° C., and 30˜120 min, the material kneading is completed;
3) filter to obtain the semi-finished silicone material;
4) after the surface of the semi-finished silicone material is cured, spray touch oil on the surface of the semi-finished silicone material.

The raw material ratio of the touch oil is: 20˜80 parts of vinyl-terminated polymethyl siloxane, 1˜20 parts of silica, 2˜20 parts of structure inhibitor, 0.1˜3 parts of methyl silicone oil, 2˜15 parts of anti-frost agent, 2˜20 parts of anti-yellowing agent, 0.2˜3 parts of platinum catalyst, 10˜100 parts of organic solvent.

### Embodiment 2

A silicone material with scratch resistance, high elongation and high resilience, comprising the following parts by weight of raw materials: 100 parts of 107 crude silicone, 0 parts of 110 crude silicone, 20 parts of structure inhibitor, 0.1 parts of methyl silicone oil, 40 parts of fumed silica, 1 parts of precipitated silica, 15 parts of anti-frost agent, 2 parts of anti-yellowing agent and 3 parts of platinum catalyst.

A silicone material with scratch resistance, high elongation and high resilience according to claim 1 is produced through the following steps:

1) add 107 crude silicone, 110 crude silicone, structure inhibitor, methyl silicone oil, fumed silica, precipitated silica, anti-frost agent, anti-yellowing agent and platinum catalyst to the kneader in order;

2) after maintaining the speed of 5˜50r/min, the temperature of 100° C.˜200° C., and 30˜120 min, the material kneading is completed;

3) filter to obtain the semi-finished silicone material;

4) after the surface of the semi-finished silicone material is cured, spray touch oil on the surface of the semi-finished silicone material.

The raw material ratio of the touch oil is: 20˜80 parts of vinyl-terminated polymethyl siloxane, 1˜20 parts of silica, 2˜20 parts of structure inhibitor, 0.1˜3 parts of methyl silicone oil, 2˜15 parts of anti-frost agent, 2˜20 parts of anti-yellowing agent, 0.2˜3 parts of platinum catalyst, 10˜100 parts of organic solvent.

### Embodiment 3

A silicone material with scratch resistance, high elongation and high resilience, comprising the following parts by weight of raw materials: 50 parts of 107 crude silicone, 50 parts of 110 crude silicone, 11 parts of structure inhibitor, 1.5 parts of methyl silicone oil, 20 parts of fumed silica, 20 parts of precipitated silica, 8 parts of anti-frost agent, 11 parts of anti-yellowing agent and 1.6 parts of platinum catalyst.

A silicone material with scratch resistance, high elongation and high resilience according to claim 1 is produced through the following steps:

1) add 107 crude silicone, 110 crude silicone, structure inhibitor, methyl silicone oil, fumed silica, precipitated silica, anti-frost agent, anti-yellowing agent and platinum catalyst to the kneader in order;

2) after maintaining the speed of 5˜50r/min, the temperature of 100° C.˜200° C., and 30˜120 min, the material kneading is completed;

3) filter to obtain the semi-finished silicone material;

4) after the surface of the semi-finished silicone material is cured, spray touch oil on the surface of the semi-finished silicone material.

The raw material ratio of the touch oil is: 20˜80 parts of vinyl-terminated polymethyl siloxane, 1˜20 parts of silica, 2˜20 parts of structure inhibitor, 0.1˜3 parts of methyl silicone oil, 2˜15 parts of anti-frost agent, 2˜20 parts of anti-yellowing agent, 0.2˜3 parts of platinum catalyst, 10˜100 parts of organic solvent.

The above descriptions are only preferred embodiments of the invention, but the protection scope of the invention is not limited to this. The equivalent replacements or changes according to the technical solutions of the invention and its inventive concept within the technical scope disclosed by the invention created by any person skilled in the art shall all fall within the protection scope of the invention.

1. A silicone material with scratch resistance, high elongation and high resilience, comprising the following parts by weight of raw materials: 0˜100 parts of 107 crude silicone, 0˜100 parts of 110 crude silicone, 2˜20 parts of structure inhibitor, 0.1˜3 parts of methyl silicone oil, 1˜40 parts of fumed silica, 1˜40 parts of precipitated silica, 2˜15 parts of anti-frost agent, 2˜20 parts of anti-yellowing agent and 0.2˜3 parts of platinum catalyst.

2. The silicone material with scratch resistance, high elongation and high resilience according to claim 1 is produced through the following steps:
1) add 107 crude silicone, 110 crude silicone, structure inhibitor, methyl silicone oil, fumed silica, precipitated silica, anti-frost agent, anti-yellowing agent and platinum catalyst to the kneader in order;
2) after maintaining the speed of 5˜50r/min, the temperature of 100° C.˜200° C., and 30˜120 min, the material kneading is completed;
3) filter to obtain the semi-finished silicone material;
4) after the surface of the semi-finished silicone material is cured, spray touch oil on the surface of the semi-finished silicone material.

3. The silicone material with scratch resistance, high elongation and high resilience according to claim 2, wherein the raw material ratio of the touch oil is: 20˜80 parts of vinyl-terminated polymethyl siloxane, 1˜20 parts of silica, 2˜20 parts of structure inhibitor, 0.1˜3 parts of methyl silicone oil, 2˜15 parts of anti-frost agent, 2˜20 parts of anti-yellowing agent, 0.2˜3 parts of platinum catalyst, 10˜100 parts of organic solvent.
